(19) United States
(12) Patent Application Publication
(10) Pub. No.: US 2011/0129154 A1
(43) Pub. Date: Jun. 2, 2011

(54) Image Processing Apparatus, Image Processing Method, and Computer Program

(75) Inventor: Masato Shimodaira, Osaka (JP)

(73) Assignee: Keyence Corporation, Osaka (JP)

(21) Appl. No.: 12/943,290

(22) Filed: Nov. 10, 2010

(30) Foreign Application Priority Data
Dec. 1, 2009 (JP) 2009-273971

(51) Int. Cl. G06K 9/46

(52) U.S. Cl. 382/190

(57) ABSTRACT

The distortion correction is carried out by acquiring the calibration pattern image by an imaging device and executing calibration based on the acquired calibration pattern image. A plurality of calibration pattern images in which feature points arranged in an imaging range from which images can be picked up by the imaging device are provided at a regular interval is acquired, and a feature point group is extract from each image. The calibration is executed based on the feature point groups respectively extracted from areas with different imaging ranges.

### CROSS-REFERENCE TO RELATED APPLICATIONS

The present application claims foreign priority based on Japanese Patent Application No. 2009-273971, filed Dec. 1, 2009, the contents of which is incorporated herein by reference.

### BACKGROUND OF THE INVENTION

1. Field of the Invention

The present invention relates to an image processing technology capable of carrying out distortion correction with high accuracy based on a calibration pattern image acquired by an imaging device.

2. Description of Related Art

Conventionally, there have been developed various inspection systems and defect detection systems for determining whether or not a test object is non-defective by picking up an image of the test object using an imaging device, and then inspecting the test object and detecting a defect of the test object using a multivalued image that has been picked up. However, when acquiring an image using an imaging device, the image is often distorted due to lens distortion and perspective distortion and it is not possible to use the image as it is for determination of non-defectiveness and the like without carrying out appropriate distortion correction.

In order to solve the above problem, “A Flexible New Technique for Camera Calibration” (Zhang Z., Technical Report MSR-TR-98-71, Microsoft Research, 1998), for example, discloses a method of acquiring a plurality of images of a calibration pattern having a certain regularity at different inclination angles, and obtaining internal parameters such as lens distortion and a focal length of an imaging device and external parameters such as a three-dimensional position and a posture of the imaging device. In this manner, the images that have been picked up can be appropriately corrected by distortion correction, and it is possible to carry out non-defective determination with higher accuracy.

### SUMMARY OF THE INVENTION

According to the method disclosed in “A Flexible New Technique for Camera Calibration”, it is required to acquire a plurality of images of a calibration pattern at different inclination angles. Therefore, it is necessary to pick up images while varying a relative inclination angle between an imaging device and the calibration pattern many times, which poses a problem that acquisition of images becomes cumbersome.

Further, when the number of parameters to be obtained is large and the number of acquired images is small, it is often not possible to specify all of these parameters. Therefore, there has been a problem in that the parameters cannot be obtained correctly in the case where the relative inclination angle between the imaging device and the calibration pattern is not appropriate.

The present invention relates to an image processing apparatus, an image processing method, and a computer program capable of simplifying steps of acquiring images of a calibration pattern as well as of carrying out distortion correction in a wider area with high accuracy.

According to one embodiment of the present invention, there is provided an image processing apparatus that performs distortion correction by acquiring a calibration pattern image using an imaging device and by executing calibration based on the acquired calibration pattern image, the image processing apparatus including: a first extraction device that acquires a calibration pattern image in which first feature points arranged in an imaging range pickable by the imaging device are provided at a first interval and that extracts a first feature point group; and a second extraction device that acquires a calibration pattern image in which second feature points arranged in an imaging range pickable by the imaging device are provided at a second interval and that extracts a second feature point group, wherein the calibration is executed based on the first feature point group and the second feature point group respectively extracted from areas with different imaging ranges.

According to another embodiment of the present invention, in the image processing apparatus, the second interval is set so as to be wider than the first interval, and the first extraction device extracts the first feature point group in an area in which the feature points are sparsely shown, and the second extraction device extracts the second feature point group in an area in which the feature points are densely shown. As used herein, the “area in which the feature points are sparsely shown” refers to an area in which the feature points are shown narrower than the predetermined interval with respect to a display screen displayed by a predetermined number of pixels, and the “area in which the feature point are densely shown” refers to an area in which the feature points are shown wider than the predetermined interval with respect to the display screen displayed by the predetermined number of pixels.

According to another embodiment of the present invention, the image processing apparatus further includes: a setting device that sets one of a plurality of calibration pattern images as a reference image; a projective transformation parameter setting device that sets projective transformation parameters indicating a relation between a first coordinate system and a second coordinate system, the first coordinate system representing the reference image shown in a planar view, the second coordinate system being for displaying the reference image; an affine transformation parameter setting device that sets a relation between the reference image and the calibration pattern image other than the reference image by affine transformation parameters including a scaling factor in the first coordinate system based on the reference image; a lens distortion parameter setting device that sets lens distortion parameters for correcting lens distortion and a relation between the lens distortion parameters by the imaging device; and a parameter optimizing device that optimizes the projective transformation parameters, the affine transformation parameters, and the lens distortion parameters based on coordinate data based on the reference image in the first coordinate system and coordinate data of the feature points in a plurality of arrangements including the reference image displayed in the second coordinate system.

According to another embodiment of the present invention, the image processing apparatus further includes: a projective transformation parameter calculating device that calculates estimated values of the projective transformation parameters on an assumption that the lens distortion is not present; and an affine transformation parameter calculating device that calculates estimated values of the affine transformation parameters on the assumption that the lens distortion is not present, wherein the parameter optimizing device optimizes the projective transformation parameters, the affine transformation parameters, and the lens distortion parameters, taking the estimated values of the projective transformation parameters and the estimated values of the affine transformation parameters as initial values.

According to another embodiment of the present invention, the image processing apparatus further includes: a selection accepting device that accepts a selection between whether or not more than one calibration pattern images are used.

According to another embodiment of the present invention, the image processing apparatus further includes: a feature point display device that displays at least one of the first feature point group and the second feature point group used for executing the calibration.

According to another embodiment of the present invention, the image processing apparatus further includes: an acquisition instruction accepting device that accepts an input of an instruction of re-acquisition to the imaging device for each calibration pattern image that are accepted to be selected by the selection setting accepting device.

According to another embodiment of the present invention, the image processing apparatus further includes: an extraction area display device that displays an area from which at least one of the first feature point group and the second feature point group is extracted.

Further, according to another embodiment of the present invention, there is provided an image processing method capable of being carried out by an image processing apparatus that performs distortion correction by acquiring a calibration pattern image using an imaging device and by executing calibration based on the acquired calibration pattern image, the method including the steps of acquiring a calibration pattern image in which first feature points arranged in an imaging range pickable by the imaging device are provided at a first interval and to extract a first feature point group; acquiring a calibration pattern image in which second feature points arranged in an imaging range pickable by the imaging device are provided at a second interval and to extract a second feature point group; and executing the calibration based on the first feature point group and the second feature point group respectively extracted from areas with different imaging ranges.

Next, according to another embodiment of the present invention, there is provided a computer program capable of being executed on an image processing apparatus that performs distortion correction by acquiring a calibration pattern image using an imaging device and by executing calibration based on the acquired calibration pattern image, the computer program causing the image processing apparatus to function as: a first extraction device that acquires a calibration pattern image in which first feature points arranged in an imaging range pickable by the imaging device are provided at a first interval and that extracts a first feature point group; a second extraction device that acquires a calibration pattern image in which second feature points arranged in an imaging range pickable by the imaging device are provided at a second interval and that extracts a second feature point group; and a device that executes the calibration based on the first feature point group and the second feature point group respectively extracted from areas with different imaging ranges.

According to the embodiment of the present invention, the distortion correction is performed by acquiring the calibration pattern image using the imaging device and by executing the calibration based on the acquired calibration pattern image. The calibration pattern image in which the first feature points arranged in the imaging range pickable by the imaging device are provided at the first interval is acquired and the first feature point group is extracted. Likewise, the calibration pattern image in which the second feature points arranged in the imaging range pickable by the imaging device are provided at the second interval is acquired and the second feature point group is extracted. The calibration is executed based on the first feature point group and the second feature point group respectively extracted from areas with different imaging ranges. As the feature point groups are extracted in separate areas based on the calibration pattern images in which the intervals between the feature points are different, it is possible to reduce an area in which the feature points are difficult to be extracted, and it is possible to execute the calibration in a wider area.

Further, the second interval is set so as to be wider than the first interval, the first feature point group in an area in which the feature points are sparsely shown is extracted, and the second feature point group in an area in which the feature point are densely shown is extracted. Accordingly, the calibration pattern image in which the intervals between the feature points are narrow is used in the area in which the feature points can be sparsely shown, and the calibration pattern image in which the intervals between the feature points are wide is used in the area in which the feature points can be densely shown, and whereby it is possible to execute the calibration in a wider area with high accuracy.

Further, one of the plurality of calibration pattern images is set as the reference image, and the projective transformation parameters indicating the relation between the first coordinate system and the second coordinate system are set, where the first coordinate system represents the reference image shown in a planar view, and the second coordinate system is for displaying the reference image. Further, the relation between the reference image and the calibration pattern image other than the reference image is set by affine transformation parameters including the scaling factor in the first coordinate system based on the reference image, and the lens distortion parameters for correcting the lens distortion and the relation between the lens distortion parameters are set by the imaging device. The projective transformation parameters, the affine transformation parameters, and the lens distortion parameters are optimized based on coordinate data based on the reference image in the first coordinate system and coordinate data of the feature points in a plurality of arrangements including the reference image displayed in the second coordinate system. Accordingly, adverse effects such as dead pixels in the process of the coordinate system transformation can be eliminated, and it is possible to increase reliability of the calibration and to obtain the projective transformation parameters and the lens distortion parameters with high accuracy.

Further, the estimated values of the projective transformation parameters are calculated on the assumption that the lens distortion is not present, and the estimated values of the affine transformation parameters are calculated on the assumption that the lens distortion is not present. The projective transformation parameters, the affine transformation parameters, and the lens distortion parameters are optimized taking the estimated values of the projective transformation parameters and the estimated values of the affine transformation parameters as initial values, and thus the possibility that each parameter cannot be specified due to divergence in the process of the coordinate system transformation can be eliminated, and it is possible to increase reliability of the calibration and to obtain the projective transformation parameters and the lens distortion parameters with high accuracy.

Further, the selection setting accepting device that accepts the selection between whether or not more than one calibration pattern image is used is further provided, and therefore it is possible to select between whether or not more than one calibration pattern image is used depending on the magnitude of the image distortion.

Further, at least one of the first feature point group and the second feature point group used for executing the calibration is displayed, and therefore it is possible to visually confirm which feature point group is extracted from which portion in the image, and to easily determine the reliability of the calibration that has been executed.

Further, it is possible to accept the input of the instruction of the re-acquisition to the imaging device for each calibration pattern image that are accepted to be selected. Therefore, when the calibration pattern image does not sufficiently correspond to the image distortion, for example, even when the intervals between the feature points are narrow (wide) in the calibration pattern image in the area in which the feature points are densely (sparsely) shown, it is possible to execute the calibration in a wider area with high accuracy by newly acquiring a calibration pattern image in which intervals between feature points are wide (narrow).

Further, the area from which at least one of the first feature point group and the second feature point group is extracted is displayed, and therefore it is possible to visually confirm which feature point group is extracted from which portion in the image, and to increase the reliability of the calibration to be executed.

According to the embodiment of the present invention, the feature point groups are extracted in separate areas based on the calibration pattern images in which the intervals between the feature points are different. Therefore, it is possible to reduce an area in which the feature points is difficult to be extracted, and it is possible to execute the calibration in a wider area. For example, the calibration pattern image in which the intervals between the feature points are narrow is used in the area in which the feature points can be sparsely shown, and the calibration pattern image in which the intervals between the feature points are wide is used in the area in which the feature points can be densely shown, and whereby it is possible to execute the calibration in a wider area with high accuracy.

### BRIEF DESCRIPTION OF THE DRAWINGS

FIG. 1 is a block diagram schematically showing a structure of an image processing apparatus according to an embodiment of the present invention;

FIG. 2 is a functional block diagram showing a constitutional example of the image processing apparatus according to the embodiment of the present invention;

FIGS. 3A and 3B are illustrative views each showing a distribution of feature points when using a calibration pattern image in which intervals between the feature points are the same;

FIGS. 4A to 4C are illustrative views showing a plurality of calibration pattern images acquired by the image processing apparatus according to the embodiment of the present invention;

FIG. 5 is an illustrative view showing a state in which projective transformation from a world coordinate system to a pixel coordinate system is carried out;

FIGS. 6A and 6B are illustrative views each showing a state in which coordinates of feature points in a calibration pattern image in the pixel coordinate system are transformed into those in the world coordinate system;

FIG. 7 is an illustrative view showing a relation between positions of the feature points in a reference image in the world coordinate system and a position of a feature point group in calibration pattern images other than the reference image in the world coordinate system transformed in FIGS. 6A and 6B;

FIG. 8 is a flowchart showing processing steps of calibration by a main control section of an image processing section of the image processing apparatus according to the embodiment of the present invention;

FIG. 9 is an illustrative view showing a calibration setting screen for setting information that is required in order to execute the calibration of the image processing apparatus according to the embodiment of the present invention;

FIG. 10 is an illustrative view showing an image registration screen for acquiring calibration pattern image data of the image processing apparatus according to the embodiment of the present invention;

FIG. 11 is an illustrative view showing a calibration setting screen for presenting a result of execution of the calibration of the image processing apparatus according to the embodiment of the present invention;

FIG. 12 is an illustrative view showing an image registration screen for registering calibration pattern image data of the image processing apparatus according to the embodiment of the present invention;

FIG. 13 is an illustrative view showing a calibration setting screen with which a scaling factor can be set in the image processing apparatus according to the embodiment of the present invention;

FIG. 14 is a flowchart showing processing steps of image processing after the execution of the calibration by the main control section of the image processing section in the image processing apparatus according to the embodiment of the present invention; and

FIGS. 15A to 15C are illustrative views each showing an image after distortion correction.

### DETAILED DESCRIPTION OF PREFERRED EMBODIMENTS

The following describes an image processing apparatus according to an embodiment of the present invention with reference to the drawings. It is to be noted that components having the same or like structures or functions are denoted by the same or like reference numerals throughout the drawings to be referenced, and that those components already described will not be described in detail.

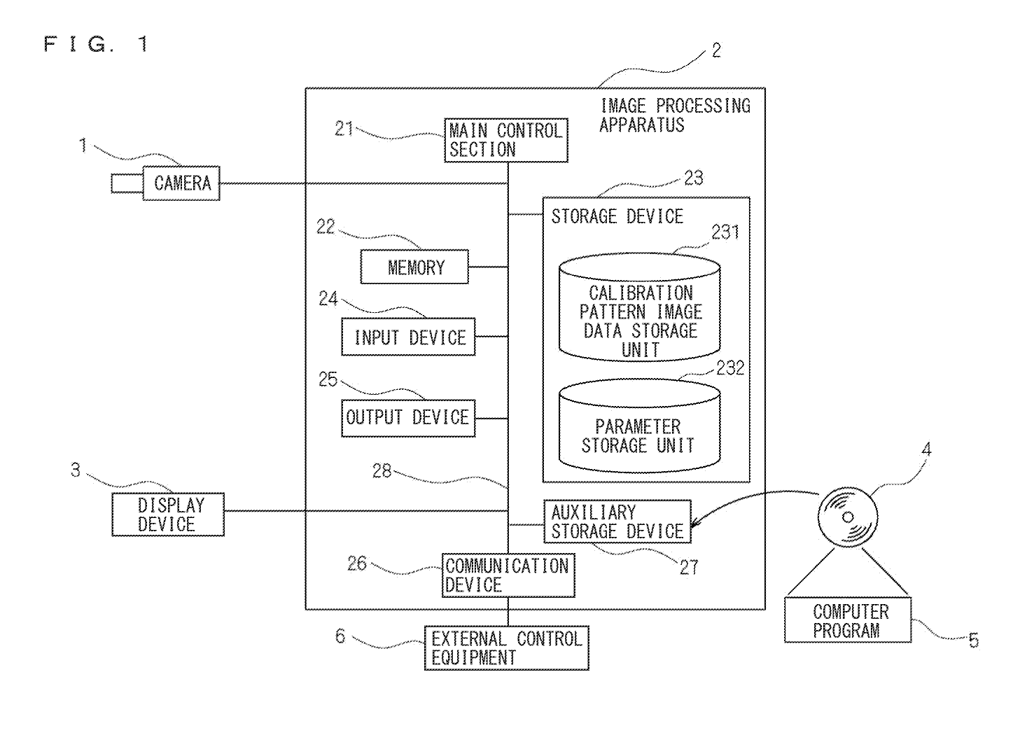

FIG. 1 is a block diagram schematically showing a structure of the image processing apparatus according to the embodiment of the present invention. As shown in FIG. 1, an image processing apparatus 2 according to the present embodiment is connected to a camera 1 as an imaging device that acquires a calibration pattern image and a display device 3 that displays an acquired calibration pattern image or a calibration pattern image after an image transformation process of various types is executed.

The image processing apparatus 2 is provided with a main control section 21 configured by at least a CPU (central processing unit), an LSI, or the like, a memory 22, a storage device 23, an input device 24, an output device 25, a communication device 26, an auxiliary storage device 27, and an internal bus 28 to which the above hardware components are connected. The main control section 21 is connected to the hardware components of the image processing apparatus 2 as described above via the internal bus 28, and controls operations of the hardware components and executes various software functions according to a computer program 5 stored in the storage device 23. The memory 22 is configured by a volatile memory such as an SRAM or an SDRAM, in which a load module is extracted when executing the computer program 5 and temporary data or the like created when executing the computer program 5 is stored.

The storage device 23 is configured by a built-in fixed storage device (hard disk or flash memory), an ROM, or the like. The computer program 5 stored in the storage device 23 is downloaded from a portable recording medium 4 such as a DVD, a CD-ROM, or a flash memory in which pieces of information such as the program and the data are stored to the auxiliary storage device 27. In execution, the computer program 5 is extracted from the storage device 23 to the memory 22 and executed. It should be appreciated that the computer program 5 can be a computer program downloaded via the communication device 26 from an external computer.

The storage device 23 is provided with a calibration pattern image data storage unit 231 that stores image data of acquired calibration pattern images, and a parameter storage unit 232 that stores various parameters such as projective transformation parameters calculated by executing calibration, lens distortion parameters, and affine transformation parameters for generating a desired post-correction image for which a user input has been accepted. The calibration pattern image data storage unit 231 stores the image data of the calibration pattern images from which feature points arranged with a certain regularity can be extracted. The image data of the plurality of calibration pattern images are picked up by changing only a position for arranging the calibration pattern without changing a position, an angle, and the like of the camera 1 with respect to an imaging area, and stored. The parameter storage unit 232 stores the parameters necessary for carrying out distortion correction that are referenced when generating a post-correction image. These parameters are calculated, set, and stored by a parameter adjustment process for executing the calibration and generating a desired post-correction image that is carried out when setting. When executing an inspection, for example, these parameters are referenced and a generation process of the post-correction image (distortion correction) is executed.

The communication device 26 is connected to the internal bus 28, and is able to transmit and receive data with an external computer and the like by being connected to an external network such as the Internet, a LAN, or a WAN. Specifically, the configuration of the storage device 23 is not limited to a built-in type in the image processing apparatus 2, and can be an external recording medium such as a hard disk provided for an external server computer or the like connected via the communication device 26.

The input device 24 represents a wide concept generally including a variety of devices that acquire inputted information of a touch panel or the like integrated with a liquid crystal panel or the like, in addition to data input media such as a keyboard and a mouse. The output device 25 refers to a printing device such as a laser printer or a dot printer.

The camera (imaging device) 1 is a CCD camera or the like provided with a CCD imaging device. The display device 3 is a display device provided with a CRT, a liquid crystal panel, or the like. The components such as the camera 1 and the display device 3 can be integrated with the image processing apparatus 2 or can be provided separately. External control equipment 6 is a control device connected via the communication device 26, and corresponds to a PLC (programmable logic controller), for example. As used herein, the external control equipment 6 represents a wide concept generally including a variety of devices that execute post-processing in response to a result of image processing by the image processing apparatus 2.

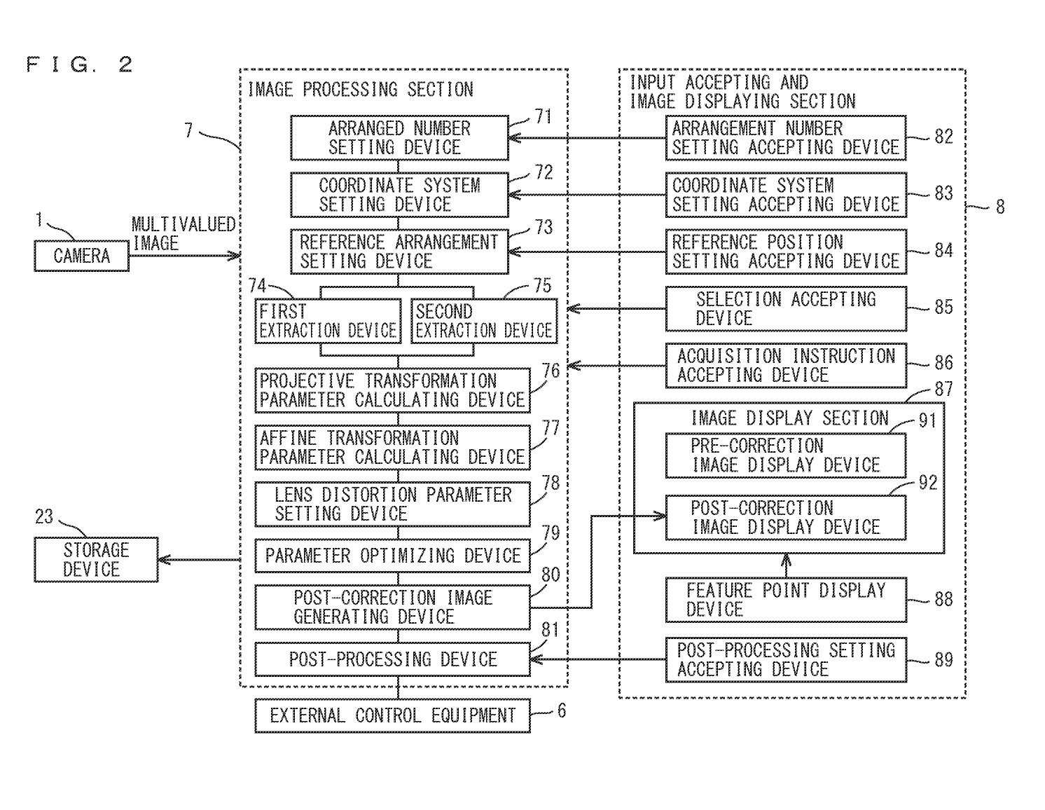

FIG. 2 is a functional block diagram showing a constitutional example of the image processing apparatus 2 according to the embodiment of the present invention. Referring to FIG. 2, the image processing apparatus 2 according to the present embodiment is provided with the camera 1, an image processing section 7 that executes the process of the image processing apparatus 2, the storage device 23, and an input accepting and image displaying section 8.

The camera 1 is configured by a digital camera, for example, and picks up and acquires an image of a calibration pattern of the feature points arranged at regular intervals, such as a chessboard pattern or a dot pattern as multivalued image data, and outputs the data to the image processing section 7.

The image processing section 7 is provided with an arranged number setting device 71, a coordinate system setting device 72, a reference arrangement setting device 73, a first extraction device 74, a second extraction device 75, a projective transformation parameter calculating device 76, an affine transformation parameter calculating device 77, a lens distortion parameter setting device 78, a parameter optimizing device 79, a post-correction image generating device 80, and a post-processing device 81. The image processing section 7 also includes the main control section 21, the memory 22, and the various interfaces with the external devices shown in FIG. 1, and controls processing operations of the arranged number setting device 71, the coordinate system setting device 72, the reference arrangement setting device 73, the first extraction device 74, the second extraction device 75, the projective transformation parameter calculating device 76, the affine transformation parameter calculating device 77, the lens distortion parameter setting device 78, the parameter optimizing device 79, the post-correction image generating device 80, and the post-processing device 81.

The storage device 23 functions as an image memory or a device for storing the various parameters required for the processing, and stores the image data of the calibration pattern image acquired by the camera 1, as well as the various parameters such as the projective transformation parameters calculated by executing the calibration, the lens distortion parameters, the affine transformation parameters for generating the desired post-correction image for which the user input has been accepted as needed. The images can be stored as data of a brightness value for each pixel, instead of as the image data.

The input accepting and image displaying section 8 is configured by the display device 3 such as a monitor for a computer and the input device 24 such as the mouse and the keyboard. The input accepting section is provided as a dialogue box, for example, in a display screen of the display device 3, and includes an arrangement number setting accepting device 82, a coordinate system setting accepting device 83, a reference position setting accepting device 84, a selection accepting device 85, an acquisition instruction accepting device 86, and a post-processing setting accepting device 89. The image display section 87 is provided adjacent to the input accepting section in the display screen of the display device 3, and includes a pre-correction image display device 91 and a post-correction image display device 92. The user is able to cause the image display section 87 to display the acquired calibration pattern images, the post-correction images, and the like in the display screen of the display device 3. Further, by a feature point display device 88, it is possible to display a feature point group that has been extracted and an area from which the feature point group is extracted overlapped with each other.

Next, the components of the image processing section 7 will be described.

The arranged number setting device 71 sets a number of the calibration pattern images for executing the calibration to be arranged in an area in which the camera 1 is able to carry out the imaging. An input of the number to be arranged is accepted by the arrangement number setting accepting device 82 in the input accepting and image displaying section 8. In the present embodiment, the number to be arranged can be “1”, that is, only one calibration pattern image can be arranged, or a plurality of calibration pattern images having the same or different intervals between the feature points can be arranged.

The coordinate system setting device 72 sets a world coordinate system (first coordinate system) representing the calibration pattern image shown in a planar view. An input of information regarding the setting of the world coordinate system is accepted by the coordinate system setting accepting device 83 in the input accepting and image displaying section 8. Specifically, an input of information such as a coordinate position and a coordinate interval of a reference image in the world coordinate system are accepted.

The reference arrangement setting device (setting device) 73 sets a calibration pattern image to be a reference out of the plurality of arranged calibration pattern images as the reference image. The setting of the calibration pattern image to be a reference is accepted by the reference position setting accepting device 84 of the input accepting and image displaying section 8.

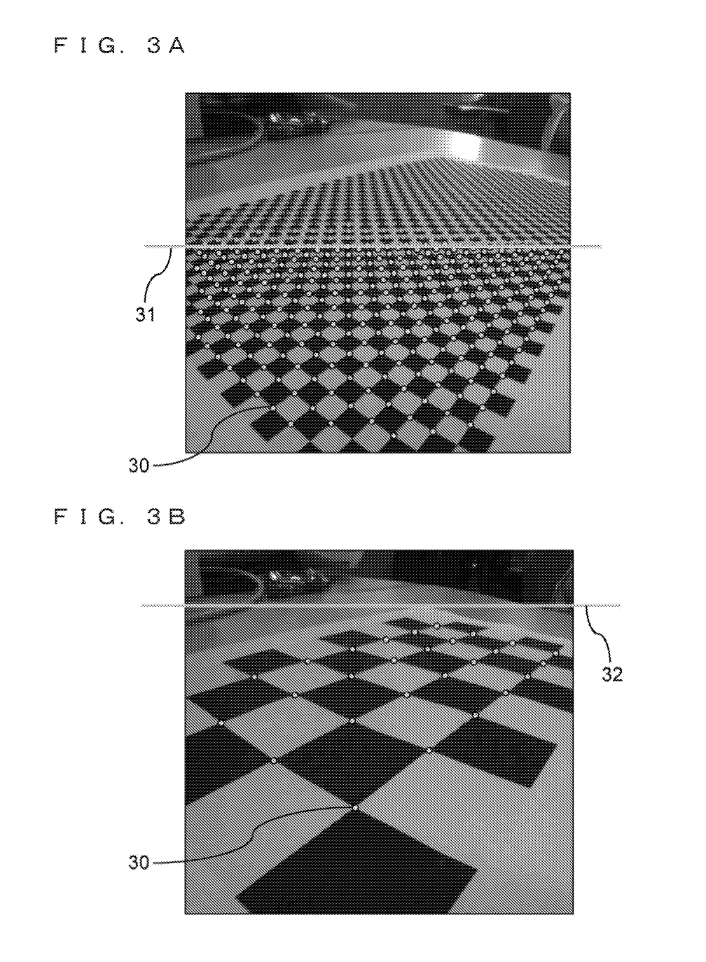

The first extraction device 74 and the second extraction device 75 each extract a feature point group from image data of a calibration pattern image in which the feature points are arranged at a regular interval. Each of FIGS. 3A and 3B is an illustrative view showing a distribution of the feature points in a calibration pattern image in which the intervals between the feature points are the same.

FIG. 3A shows an example in which the intervals between the feature points are relatively narrow, and FIG. 3B shows an example in which the intervals between the feature points are relatively wide. FIGS. 3A and 3B both show an example of a calibration pattern in a chessboard pattern with feature points 30, 30, . . . taken as vertices of black squares. While it is possible to execute the calibration with high accuracy when the intervals between the feature points are relatively narrow as shown in FIG. 3A, an area from which the feature points are correctly extracted, that is, an area in which the feature points are densely shown is limited to a portion under a boundary line 31, and the calibration can be executed only in a narrow area.

In contrast, while it is not possible to execute the calibration with high accuracy when the intervals between the feature points 30, 30, . . . are relatively wide as shown in FIG. 3B, the area from which the feature points 30, 30, . . . are correctly extracted is enlarged up to a boundary line 32, and an area in which the calibration can be executed, that is, an area in which the feature points are sparsely shown becomes wider as compared to FIG. 3A. Therefore, it is possible to execute the calibration in a wider area with high accuracy by combining the both according to a magnitude of image distortion.

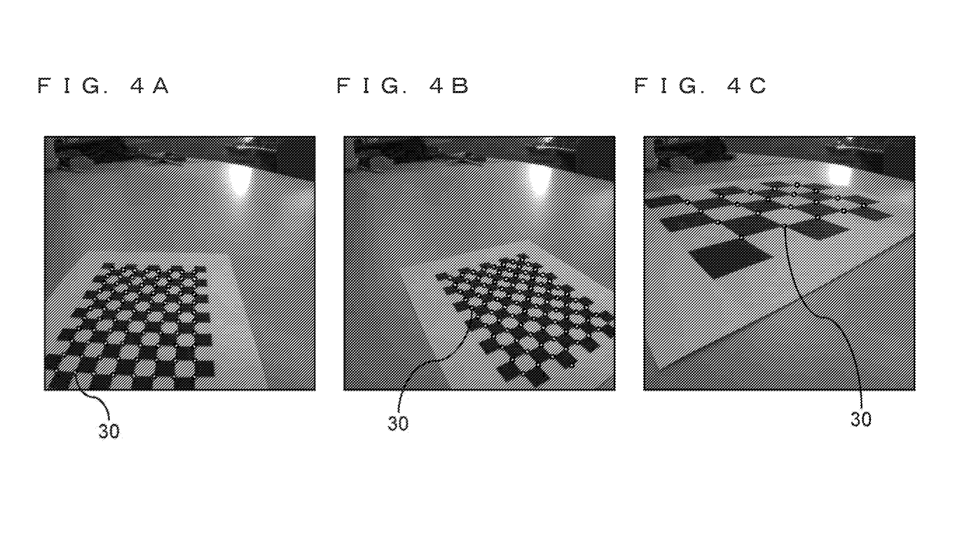

FIGS. 4A to 4C are illustrative views showing a plurality of calibration pattern images acquired by the image processing apparatus 2 according to the embodiment of the present invention. In the examples shown in FIGS. 4A to 4C, FIG. 4B shows the calibration pattern image in which the intervals between the feature points 30, 30, . . . are the same as those in an example shown in FIG. 4A, and only the arrangement is changed. Further, FIG. 4C shows the calibration pattern image in which the intervals between the feature points 30, 30, . . . are wider than those in the example shown in FIG. 4A, and the arrangement is also changed.

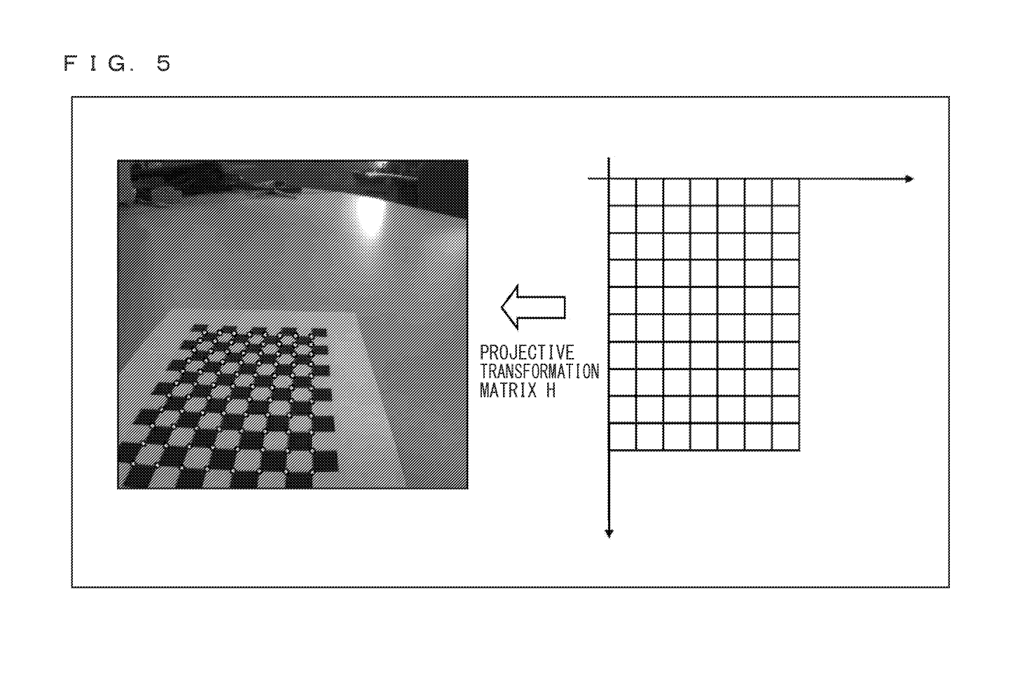

Referring back to FIG. 2, the projective transformation parameter calculating device 76 calculates the projective transformation parameters for carrying out projective transformation from the world coordinate system (first coordinate system) in which the reference image is shown in a planar view to a pixel coordinate system (second coordinate system) in the display screen on which the reference image is displayed. FIG. 5 is an illustrative view showing a state in which the projective transformation from the world coordinate system to the pixel coordinate system is carried out.

In FIG. 5, a projective transformation matrix H for carrying out the projective transformation from the reference image in a planar view set in the world coordinate system to the reference image displayed in the pixel coordinate system is obtained using the calibration pattern image shown in FIG. 4A as the reference image displayed in the pixel coordinate system. Specifically, projective transformation parameters a to h that satisfy Equation 1 as a relation between coordinate data (xi, yi) in the world coordinate system to be transformed (ideal data) and coordinate data (xi′, yi′) in the pixel coordinate system as a transformation target (actual measured data) are obtained. Here, “i” represents each of the feature points 30, 30, . . . in the respective calibration pattern images. In this case, the “ideal data” refers to a value that is numerically calculated based on the coordinate position and the coordinate interval in the world coordinate, and not the “actual measured data”.

$$\begin{matrix}[ Mathematical Formula 1 ] & \\ \begin{matrix}{x}_{i}^{′} = ( {ax}_{i} + {by}_{i} + c ) / ( {gx}_{i} + {hy}_{i} + 1 ) \\ {y}_{i}^{′} = ( {dx}_{i} + {ey}_{i} + f ) / ( {gx}_{i} + {hy}_{i} + 1 ) \\ ( \begin{matrix}{x}_{i}^{′} \\ {y}_{i}^{′} \\ 1\end{matrix} ) ≅ ( \begin{matrix}a & b & c \\ d & e & f \\ g & h & 1\end{matrix} ) \times ( \begin{matrix}{x}_{i} \\ {y}_{i} \\ 1\end{matrix} )\end{matrix} \} & ( Equation 1 )\end{matrix}$$

In order to obtain the projective transformation parameters a to h, a least-square method is taken so as to minimize summation of squares of differences between the left sides and the right sides, respectively, in a state in which a denominator of Equation 1 is multiplied on both sides. The summation of the squares of the differences between the left sides and the right sides in the state in which the denominator of Equation 1 is multiplied on both sides is expressed by Equation 2.

[Mathematical Formula 2]

Σ{(axᵢ+byᵢ+c−xᵢxᵢ′g−yᵢxᵢ′h−xᵢ′)²+(dxᵢ+eyᵢ+f−xᵢyᵢ′g−yᵢyᵢ′h−yᵢ′)²} (Equation 2)

By substituting the coordinate data (xi, yi) in the world coordinate system to be transformed and the coordinate data (xi′, y1′) in the pixel coordinate system as the transformation target in Equation 2 and rearranging the equation, Equation 3 is obtained.

$$\begin{matrix}[ Mathematical Formula 3 ] & \\ {\vert {( \begin{matrix}{x}_{1} & {y}_{1} & 1 & 0 & 0 & 0 & - x * {x}_{1}^{′} & - {y}_{1} * {x}_{1}^{′} \\ 0 & 0 & 0 & {x}_{1} & {y}_{1} & 1 & - {x}_{1} * {y}_{1}^{′} & - {y}_{1} * {y}_{1}^{′} \\ {x}_{2} & {y}_{2} & 1 & 0 & 0 & 0 & - {x}_{2} * {x}_{2}^{′} & - {y}_{2} * {x}_{2}^{′} \\ 0 & 0 & 0 & {x}_{2} & {y}_{2} & 1 & - {x}_{2} * {y}_{2}^{′} & - {y}_{2} * {y}_{2}^{′} \\ {x}_{3} & {y}_{3} & 1 & 0 & 0 & 0 & - {x}_{3} * {x}_{3}^{′} & - {y}_{3} * {x}_{3}^{′} \\ 0 & 0 & 0 & {x}_{3} & {y}_{3} & 1 & - {x}_{3} * {y}_{3}^{′} & - {y}_{3} * {y}_{3}^{′} \\ & & & ⋮ & & & & \\ & & & ⋮ & & & & \\ {x}_{N} & {y}_{N} & 1 & 0 & 0 & 0 & - {x}_{N} * {x}_{N}^{′} & - {y}_{N} * {x}_{N}^{′} \\ 0 & 0 & 0 & {x}_{N} & {y}_{N} & 1 & - {x}_{N} * {y}_{N}^{′} & - {y}_{N} * {y}_{N}^{′}\end{matrix} )}_{A} \times {( \begin{matrix}a \\ b \\ c \\ d \\ e \\ f \\ g \\ h\end{matrix} )}_{x} - {( \begin{matrix}{x}_{1}^{′} \\ {y}_{1}^{′} \\ {x}_{2}^{′} \\ {y}_{2}^{′} \\ {x}_{3}^{′} \\ {y}_{3}^{′} \\ ⋮ \\ ⋮ \\ {x}_{N}^{′} \\ {y}_{N}^{′}\end{matrix} )}_{B} \vert}^{2} = {\vert Ax - B \vert}^{2} & ( Equation 3 )\end{matrix}$$

The projective transformation parameters a to h that minimize Equation 3 can be obtained by Equation 4, where a transposed matrix of a matrix A is A^{T}. Here, estimated values of the projective transformation parameters when the lens distortion is not considered are obtained. The estimated values of the projective transformation parameters are later used as initial values for obtaining optimal values by the parameter optimizing device 79, and as reference parameters for obtaining estimated values for the affine transformation parameters that will be described below.

[Mathematical Formula 4]

A^{T}Ax=A^{T}B (Equation 4)

Referring back to FIG. 2, the affine transformation parameter calculating device 77 calculates the affine transformation parameters for respective arrangements for transforming coordinate data of the feature points in the calibration pattern images other than the reference image into the world coordinate system using inverse transformation parameters of the calculated projective transformation parameters, and for carrying out affine transformation from the coordinate data based on the reference image in the world coordinate system into coordinate data of the feature points in each arrangement after transformed into the world coordinate system. Specifically, first, an inverse matrix of the projective transformation matrix H is calculated using the projective transformation parameters a to h, and the coordinate positions of the feature points 30, 30, . . . in the calibration pattern images other than the reference image, for example, the images shown by FIG. 4B and FIG. 4C out of FIGS. 4A to 4C are transformed into the world coordinate system.

Then, based on the transformed coordinate data, the relation between the arrangements in the reference image and the images other than the reference image is expressed by the affine transformation parameters S, T, θ, α in the world coordinate system (the coordinate system based on the reference image in a planar view). Here, the affine transformation parameters S and T respectively represent parallel translation distances along an X axis and along a Y axis in the world coordinate system based on the reference image, θ represents a rotational amount, and a represents a scaling factor.

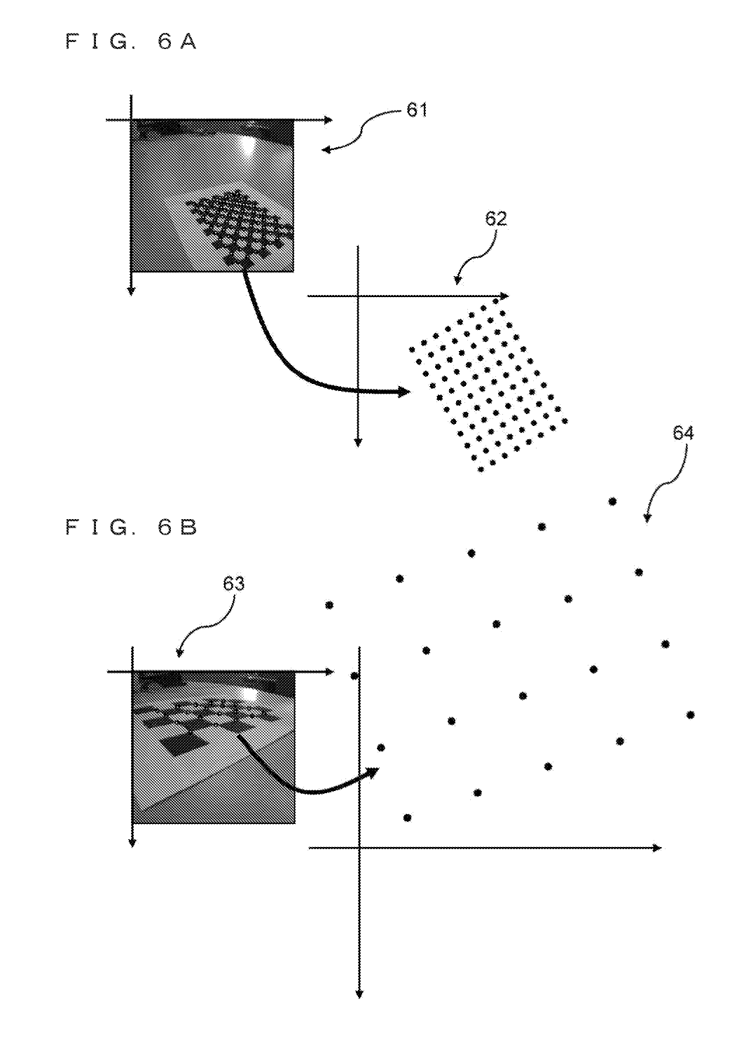

FIGS. 6A and 6B are illustrative views each showing a state in which the coordinate data of the feature points in the calibration pattern image in the pixel coordinate system is transformed into that in the world coordinate system. FIG. 6A is the illustrative view showing the state in which the feature points in the calibration pattern image shown in FIG. 4B are transformed into those in the world coordinate system, and FIG. 6B is the illustrative view showing the state in which the feature points 30, 30, . . . in the calibration pattern image shown in FIG. 4C are transformed into those in the world coordinate system.

FIG. 6A shows a state in which coordinate data of feature points in a displayed image 61 in the pixel coordinate system shown in FIG. 4B is transformed into that in a world coordinate system 62. Likewise, FIG. 6B shows a state in which coordinate data of feature points in a displayed image 63 in the pixel coordinate system shown in FIG. 4C is transformed into that in a world coordinate system 64. In this manner, as the intervals between the feature points are different in the pixel coordinate system, the intervals between the feature points in the world coordinate system are wider in FIG. 6B.

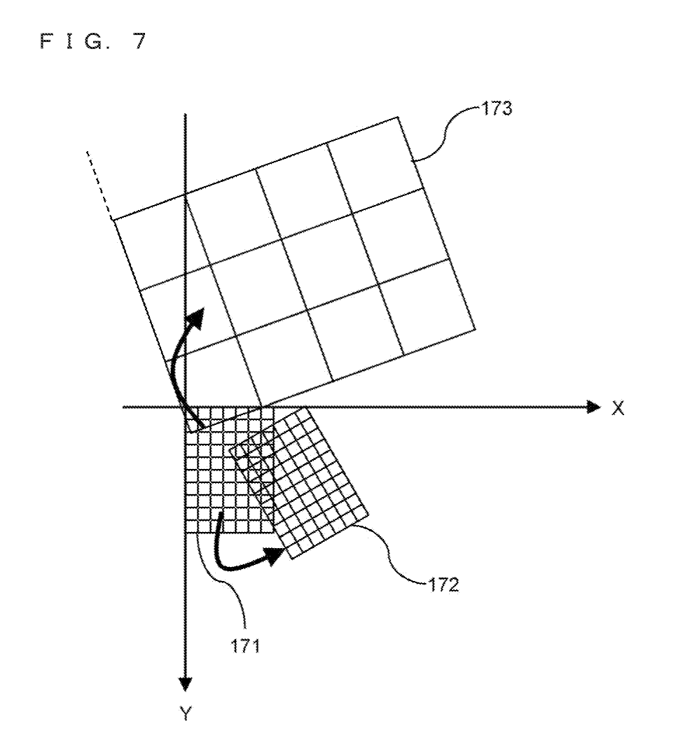

FIG. 7 is an illustrative view showing a relation between positions of the feature points in the reference image in the world coordinate system and a position of a feature point group in the world coordinate system in the calibration pattern images other than the reference image transformed in FIGS. 6A and 6B. In FIG. 7, the feature point group is shown as each vertex of a square group representing scales of the coordinates instead of a point sequence. Therefore, the feature points are positioned at the corresponding vertices of the squares included in the feature point group.

In FIG. 7, a feature point group 171 representing the positions of the feature points of the reference image, a feature point group 172 which is obtained by transforming the feature point group in the calibration pattern image corresponding to FIG. 4B into the world coordinate system, and a feature point group 173 which is obtained by transforming the feature point group in the calibration pattern image corresponding to FIG. 4C into the world coordinate system are shown in the same scale in the world coordinate system in which a feature point at an upper-left edge in the reference image in a planar view is taken as an origin point, and in which each interval between the feature points of the reference image is indicated by a single scale. In this manner, the other feature point groups 172 and 173 can be obtained by parallelly translating along the X axis and the Y axis based on the feature point group 171 of the reference image, and rotating to enlarge or reduce. Specifically, the other feature point groups 172 and 173 are respectively expressed by, with the feature point group 171 of the reference image as a reference, the parallel translation distance S in the X axis, the parallel translation distance T in the Y axis, the rotational amount θ, and the scaling factor α, which are the affine transformation parameters.

Specifically, using the parallel translation distance S in the X axis, the parallel translation distance T in the Y axis, the rotational amount θ, and the scaling factor α, which are the affine transformation parameters, the relation between the coordinate data (xi, yi) to be transformed (ideal data) and the coordinate data (xi′, yi′) as the transformation target (the data obtained by transforming the actual measured data into the world coordinate system) is expressed by Equation 5.

$$\begin{matrix}[ Mathematical Formula 5 ] & \\ \begin{matrix}{x}_{i}^{′} = α * cos θ * {x}_{i} - α * sin θ * {y}_{i} + S \\ {y}_{i}^{′} = α * sin θ * {x}_{i} + α * cos θ * {y}_{i} + T\end{matrix} \} & ( Equation 5 )\end{matrix}$$

In order to obtain the affine transformation parameters, a nonlinear least-square method can be employed so as to minimize summation of squares of differences between a left side and a right side of Equation 5. Specifically, it is sufficient if it is possible to obtain the parallel translation distance S in the X axis, the parallel translation distance T in the Y axis, the rotational amount θ, and the scaling factor α, which are the affine transformation parameters with which Equation 6 becomes minimum. Here, estimated values of the affine transformation parameters when the lens distortion is not considered are obtained. The obtained estimated values of the affine transformation parameters are later used as initial values for obtaining optimal values by the parameter optimizing device 79.

[Mathematical Formula 6]

J=Σ{(xᵢ′−α*cos θ*xᵢ+α*sin θ*yᵢ−S)²+(yᵢ′−α*sin θ*xᵢ−α*cos θ*yᵢ−T)²)} (Equation 6)

It should be noted that when the scaling factor α is fixed to “1”, the calibration can be executed using the plurality of calibration pattern images of the same size. Tolerating a value other than “1” for the scaling factor α allows the execution of the calibration using the plurality of calibration pattern images of different sizes. When using a value other than “1” for the scaling factor α, if the intervals between the feature points are known in advance, it is possible to execute the calibration more strictly by fixing the scaling factor α to an appropriate value (such as “2” or “⅓”, for example).

Referring back to FIG. 2, the lens distortion parameter setting device 78 sets the lens distortion parameters for correcting the lens distortion and relation between the lens distortion parameters. Although the relation between the lens distortion parameters is not particularly limited, the relation between the coordinate data (xi, yi) to be transformed and the coordinate data (xi′, yi′) as the transformation target can be set using four parameters including a low order lens distortion parameter K₁, a high order lens distortion parameter K₂, and an X coordinate u and a Y coordinate v at a center of the lens distortion, as expressed by Equation 7, for example. It should be noted that initial values (estimated values) for later obtaining optimal values by the parameter optimizing device 79 can be taken such that the center of the lens distortion is a center of the image, and the other high order and low order lens distortion parameters are 0 (zero).

$$\begin{matrix}[ Mathematical Formula 7 ] & \\ \begin{matrix}{x}_{i}^{′} = {x}_{i} + {K}_{1} * ( {x}_{i} - u ) * {R}_{i}^{2} + {K}_{2} * ( {x}_{i} - u ) * {R}_{i}^{4} \\ {y}_{i}^{′} = {y}_{i} + {K}_{1} * ( {y}_{i} - v ) * {R}_{i}^{2} + {K}_{2} * ( {y}_{i} - v ) * {R}_{i}^{4} \\ where {R}_{i}^{2} = {( {x}_{i} - u )}^{2} + {( {y}_{i} - v )}^{2}\end{matrix} \} & ( Equation 7 )\end{matrix}$$

The parameter optimizing device 79 optimizes the projective transformation parameters a to h, the affine transformation parameters S, T, θ, and α, and the lens distortion parameters K₁, K₂, u, and v, for which the estimated values have been previously calculated, based on the coordinate data based on the reference image in the world coordinate system (the coordinate system based on the reference image in a planar view) and the coordinate data of the feature point in the pixel coordinate system extracted for each arrangement.

Specifically, the relation between the coordinate data (xi, yi) (ideal data) based on the reference image in the world coordinate system to be transformed and coordinate data (Xₙᵢ′, Yₙᵢ′) as the transformation target (actual measured data) of feature points in a calibration pattern image n (n is a natural number from 1 to N) for all the arrangements including the reference image in the pixel coordinate system is respectively expressed by transform functions F and G, and the respective transformation parameters are calculated at once so as to minimize summation of squares of differences between these. Specifically, first, the coordinate data (xi, yi) based on the reference image in the world coordinate system is transformed into (xₙᵢ, yₙᵢ) by the affine transformation. The transformation equation is as expressed by Equation 8.

$$\begin{matrix}[ Mathematical Formula 8 ] & \\ ( \begin{matrix}{x}_{ni} \\ {y}_{ni} \\ 1\end{matrix} ) = ( \begin{matrix}αcos {θ}_{n} & - {α}_{n} sin {θ}_{n} & {S}_{n} \\ αsin {θ}_{n} & {α}_{n} cos {θ}_{n} & {T}_{n} \\ 0 & 0 & 1\end{matrix} ) \times ( \begin{matrix}{x}_{i} \\ {y}_{i} \\ 1\end{matrix} ) & ( Equation 8 )\end{matrix}$$

Next, the coordinate data (xₙᵢ, yₙᵢ) that has been transformed by the affine transformation is transformed by Equation 9 into the coordinate data (Xₙᵢ, Yₙᵢ) in the pixel coordinate system without the lens distortion.

$$\begin{matrix}[ Mathematical Formula 9 ] & \\ ( \begin{matrix}{X}_{ni} \\ {Y}_{ni} \\ 1\end{matrix} ) ≅ ( \begin{matrix}a & b & c \\ d & e & f \\ g & h & 1\end{matrix} ) \times ( \begin{matrix}{x}_{ni} \\ {y}_{ni} \\ 1\end{matrix} ) & ( Equation 9 )\end{matrix}$$

Further, the coordinate data is transformed into the coordinate data (Xₙᵢ′, Yₙᵢ′) in the pixel coordinate system when the lens distortion is considered by Equation 10, using Equation 7 that expresses the relations between the lens distortion parameters.

$$\begin{matrix} [ Mathematical Formula 10 ] \\ \begin{matrix}{X}_{ni}^{′} = {X}_{ni} + {K}_{1} * ( {X}_{ni} - u ) * {R}_{ni}^{2} + {K}_{2} * ( {X}_{ni} - u ) * {R}_{i}^{4} \\ {Y}_{ni}^{′} = {Y}_{ni} + {K}_{1} * ( {Y}_{ni} - v ) * {R}_{ni}^{2} + {K}_{2} * ( {Y}_{ni} - v ) * {R}_{i}^{4} \\ where {R}_{ni}^{2} = {( {X}_{ni} - u )}^{2} + {( {Y}_{ni} - v )}^{2}\end{matrix} \}\end{matrix}$$

By combining Equations 8 to 10, the relation between the coordinate data (xi, yi) to be transformed based on the reference image in the world coordinate system, and the coordinate data (Xₙᵢ′, Yₙᵢ′) as the transformation target of the feature points in the calibration pattern image n (n is a natural number from 1 to N) for all the arrangements including the reference image can be respectively expressed by the transform functions F and G expressed by Equation 11.

$$\begin{matrix}[ Mathematical Formula 11 ] & \\ \begin{matrix}{X}_{ni}^{′} = F ( \begin{matrix}a , b , c , d , e , f , g , h , \\ {K}_{1} , {K}_{2} , u , v , {S}_{n} , {T}_{n} , {θ}_{n} , {α}_{n} , {x}_{i} , {y}_{i}\end{matrix} ) \\ {Y}_{ni}^{′} = G ( \begin{matrix}a , b , c , d , e , f , g , h , \\ {K}_{1} , {K}_{2} , u , v , {S}_{n} , {T}_{n} , {θ}_{n} , {α}_{n} , {x}_{i} , {y}_{i}\end{matrix} )\end{matrix} \} & ( Equation 11 )\end{matrix}$$

In order to optimize the parameters, the projective transformation parameters a to h, the affine transformation parameters S, T, θ, and α, and the lens distortion parameter K₁, K₂, u, and v can be calculated by the nonlinear least-square method (Levenberg-Marquardt method, for example) so as to minimize Equation 12.

$$\begin{matrix} [ Mathematical Formula 12 ] & \\ \begin{matrix} J = {\sum }_{n}^{ } {\sum }_{i}^{ } ( {X}_{dni}^{2} + {Y}_{dni}^{2} ) \\ {X}_{dni} = {X}_{ni}^{′} - F ( \begin{matrix}a , b , c , d , e , f , g , h , \\ {K}_{1} , {K}_{2} , u , v , {S}_{n} , {T}_{n} , {θ}_{n} , {α}_{n} , {x}_{i} , {y}_{i}\end{matrix} ) \\ {Y}_{dni} = {Y}_{ni}^{′} - G ( \begin{matrix}a , b , c , d , e , f , g , h , \\ {K}_{1} , {K}_{2} , u , v , {S}_{n} , {T}_{n} , {θ}_{n} , {α}_{n} , {x}_{i} , {y}_{i}\end{matrix} ) \\ n = 1 ∼ N number of arrangements \\ i = 1 ∼ {k}_{n} number of feature points in arrangement n\end{matrix} \} & ( Equation 12 )\end{matrix}$$

It should be noted that only the affine transformation parameters are different between the arrangements, and the projective transformation parameters and the lens distortion parameters can be common. This is because a positional relation between an imaging plane and the camera 1 remains unchanged, and the images in which only the arrangements of the calibration pattern are changed are picked up and acquired.

The post-correction image generating device 80 generates the image to which the distortion correction has been performed using the optimized projective transformation parameters, the lens distortion parameters, and the affine transformation parameters for accepting the user input in order to generate the post-correction images. The image display section 87 of the input accepting and image displaying section 8 is able to display the generated post-correction image in the display device 3 using the post-correction image display device 92.

It should be noted that the input of the affine transformation parameters is accepted by the input accepting and image displaying section 8. According to the embodiment of the present invention, as the position and the angle of the camera 1 are fixed, based on the reference image in the world coordinate system, it is possible to set so as to generate a post-correction image having a desired size and a desired angle at a desired position by accepting the user input taking the parallel translation distances X and Y, the rotational amount θ, and the scaling factor α as the affine transformation parameters.

In the following, a processing method of the post-correction image generating device 80 is specifically described. First, an affine transformation matrix obtained by combining the affine transformation parameters that are inputted and accepted from the user is calculated. Next, an inverse matrix of the calculated affine transformation matrix is calculated, and a combined projective transformation matrix obtained by combining the calculated inverse matrix of the affine transformation matrix and the projective transformation parameters acquired by the parameter optimizing device 79 (a projective transformation matrix) is calculated. The calculated combined projective transformation matrix is a matrix for transforming the coordinate data in the post-correction image into the coordinate data in the pre-correction image (without the lens distortion).

By using the calculated combined projective transformation matrix and the lens distortion parameters acquired by the parameter optimizing device 79, it is possible to obtain the coordinate data in the pre-correction image corresponding to the coordinate data of each pixel in the post-correction image having the desired position, the desired size, and the desired angle, and to generate the post-correction image. Specifically, first, coordinate transformation is carried out by substituting the coordinate data of each pixel in the post-correction image into Equation 1 using the combined projective transformation matrix. Next, coordinate transformation is carried out by substituting the transformed coordinate data into Equation 7 using the lens distortion parameters acquired by the parameter optimizing device 79. Accordingly, the coordinate data in the corresponding pre-correction image is acquired.

Using pixel values corresponding to the coordinate data in the acquired pre-correction image, it is possible to take a pixel value of the nearest pixel as it is as a pixel value of the pixel after the correction, or it is possible to obtain an appropriate pixel value by interpolating pixel values of pixels in an adjacent area in order to generate a post-correction image with higher accuracy. As a method of interpolation, it is possible to employ, for example, bilinear interpolation in which linear interpolation for the four nearest pixels is carried out, however the present invention is not limited thereto. As described above, it is possible to generate the post-correction image by sequentially obtaining the pixel values in the respective pixels after the correction.

When setting, adjustment is carried out targeting at the post-correction image to be generated by visually confirming the actual post-correction image, in addition to the execution of the calibration, and the adjusted affine transformation parameters are associated with the projective transformation parameters and the lens distortion parameters optimized by the parameter optimizing device 79 and stored in the parameter storage unit 232. On the other hand, when executing an inspection, a post-correction image generation process (distortion correction) is repeatedly executed to a last inputted image by referring to the stored and adjusted affine transformation parameters, and the projective transformation parameters and the lens distortion parameters that have been optimized, and it is possible to execute an inspection with high reliability by carrying out a desired post-processing to the corrected image.

The post-processing device 81 carries out the post-processing to the image that has gone through the calibration and the distortion correction by the post-processing setting accepting device 89 of the input accepting and image displaying section 8 according to selected post-processing accepted from the user. The post-processing is an inspection and image processing desired by the user, such as OCR or a pattern search. A result of the post-processing is outputted to the external control equipment 6 and an operation of an external device or the like is controlled by the external control equipment 6.

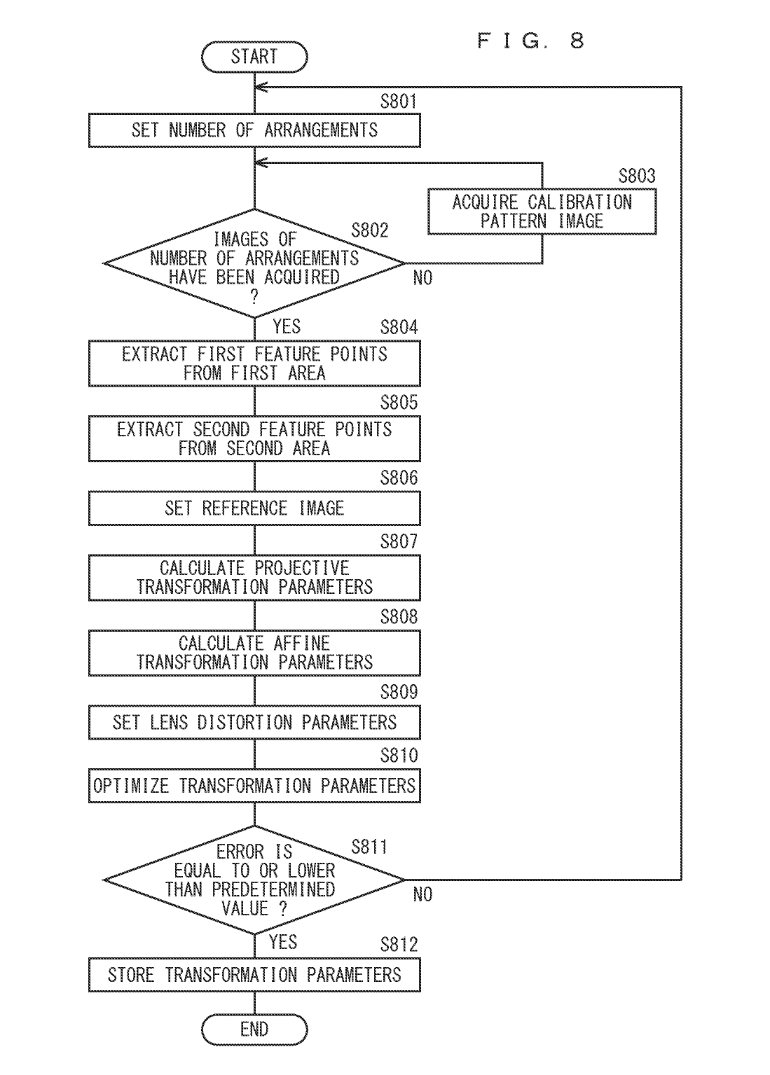

FIG. 8 is a flowchart showing processing steps of the calibration by the main control section 21 of the image processing section 7 in the image processing apparatus 2 according to the embodiment of the present invention. Each of the processing steps in an image processing method according to the embodiment of the present invention is executed according to the computer program 5 of the present invention that is internally stored in the image processing section 7.

Referring to FIG. 8, the main control section 21 of the image processing section 7 sets the number of the calibration pattern images to which the calibration is executed that are to be arranged in the pickable area of the camera 1 (step S801). The input of the number of images to be arranged is accepted by the arrangement number setting accepting device 82 of the input accepting and image displaying section 8. In the present embodiment, the number of arrangements can be “1”, that is, only one calibration pattern image can be arranged, or a plurality of calibration pattern images having different intervals between the feature points can be arranged.

The main control section 21 determines whether or not the calibration pattern images of the number of arrangements that has been set are acquired (step S802), and if the main control section 21 determines that the calibration pattern images of the number of arrangements that has been set have not been acquired (step S802: NO), the main control section 21 acquires a calibration pattern image from the camera 1 (step S803). If the main control section 21 determines that the calibration pattern images of the number of arrangements that has been set have been acquired (step S802: YES), the main control section 21 extracts feature points (first feature points) in a predetermined area (first area) (step S804), and then extracts feature points (second feature points) in an area different from the predetermined area (second area) (step S805).

In each calibration pattern image, the feature points 30, 30, . . . are arranged at a regular interval. While it is possible to execute the calibration with high accuracy when the interval between the feature points 30, 30, . . . is relatively narrow, an area from which the feature points 30, 30, . . . are correctly extracted becomes relatively narrow. In contrast, while it is not possible to execute the calibration with high accuracy when the intervals between the feature points 30, 30, . . . are relatively wide, the area from which the feature points 30, 30, . . . are correctly extracted is relatively enlarged. Therefore, it is possible to execute the calibration in a wider area with high accuracy, by extracting the feature points 30, 30, . . . from different areas according to a magnitude of the image distortion.

The main control section 21 sets the calibration pattern image to be a reference out of the plurality of calibration pattern images to be arranged as the reference image (step S806). The setting of the calibration pattern image to be a reference is accepted by the reference position setting accepting device 84 of the input accepting and image displaying section 8.

The main control section 21 calculates the projective transformation parameters (estimated values) for carrying out the projective transformation of the reference image from the world coordinate system in which the reference image is shown in a planar view to the reference image (step S807), transforms the coordinate data of the feature points in the calibration pattern images other than the reference image to the world coordinate system using the inverse transformation parameters of the calculated projective transformation parameters, and calculates correspondence between the reference image and each arrangement other than the reference image as the affine transformation parameters (estimated values) including the scaling factor in the world coordinate system based on the reference image in the world coordinate system (the coordinate system based on the reference image in a planar view) (step S808).

The main control section 21 sets the lens distortion parameters for correcting the lens distortion and relation between the lens distortion parameters (the estimated values are taken such that the center of the lens distortion is the center of the image, and the other high order and low order lens distortion parameters are 0 (zero)) (step S809), and optimizes the projective transformation parameters a to h, the affine transformation parameters S, T, θ, and α, and the lens distortion parameters K₁, K₂, u, and v that have been previously obtained by calculating the estimated values based on the coordinate data based on the reference image in the world coordinate system (the coordinate system based on the reference image in a planar view) and based on the coordinate data of the feature points in the pixel coordinate system that have been extracted from each arrangement (step S810). Each of the transformation parameters is optimized by the nonlinear least-square method or the like. It should be noted that, when the calibration is executed only to a single image, the process can be carried out by fixedly setting the values of the affine transformation parameters S, T, and θ to be “0 (zero)” and α to be “1”.

The main control section 21 determines whether or not an error when the optimized transformation parameters are used is equal to or smaller than a predetermined value (step S811). If the main control section 21 determines that the error is greater than the predetermined value (step S811: NO), the main control section 21 returns the process to step S801 and repeats the steps described above. If the main control section 21 determines that the error is equal to or smaller than the predetermined value (step S811: YES), the main control section 21 stores the transformation parameters in the storage device 23 (step S812), and uses the parameters in subsequent steps. Specifically, the projective transformation parameters a to h and the lens distortion parameters K₁, K₂, u, and v are stored, and an input of desired values as the affine transformation parameters S₀, T₀, θ₀, and α₀ for generating the desired post-correction image is accepted. After accepting the input of the desired values, the accepted affine transformation parameters are also stored.

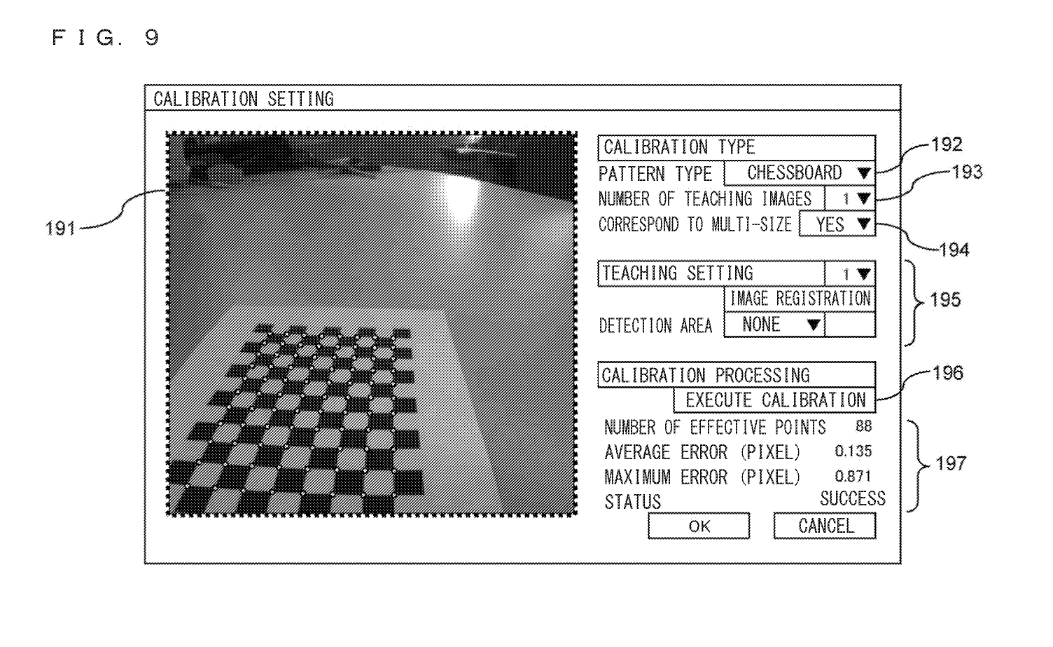

FIG. 9 is an illustrative view showing a calibration setting screen for setting information that is required in order to execute the calibration of the image processing apparatus 2 according to the embodiment of the present invention. In the example shown in FIG. 9, an image that is stored as the image data of the calibration pattern image and the extracted feature points can be displayed overlapping with each other in a calibration pattern image display area 191.

In a pattern type setting area 192, it is possible to accept selection between the calibration patterns, for example, of a chessboard type and a dot type, by a pull-down menu. In a teaching image number setting area 193, it is possible to accept specification of the number of calibration pattern images used for execution of the calibration (the selection accepting device 85). In a multi-size correspondence specifying area 194, it is possible to accept specification regarding whether or not to use images with different intervals between the feature points in the calibration pattern image.

In a calibration pattern image setting area 195, confirmation, registration, update, and the like of the calibration pattern image data used for the execution of the calibration are carried out (including the acquisition instruction accepting device 86). Specifically, an input of a registration number is accepted, and an image corresponding to the registration number and being registered at this moment and the extracted feature point group are displayed in the image display area 191. If none is registered or appropriate, an instruction is accepted through an image registration screen displayed as a pop-up by selecting an image registration button to newly acquire or re-acquire (the acquisition instruction accepting device 86).

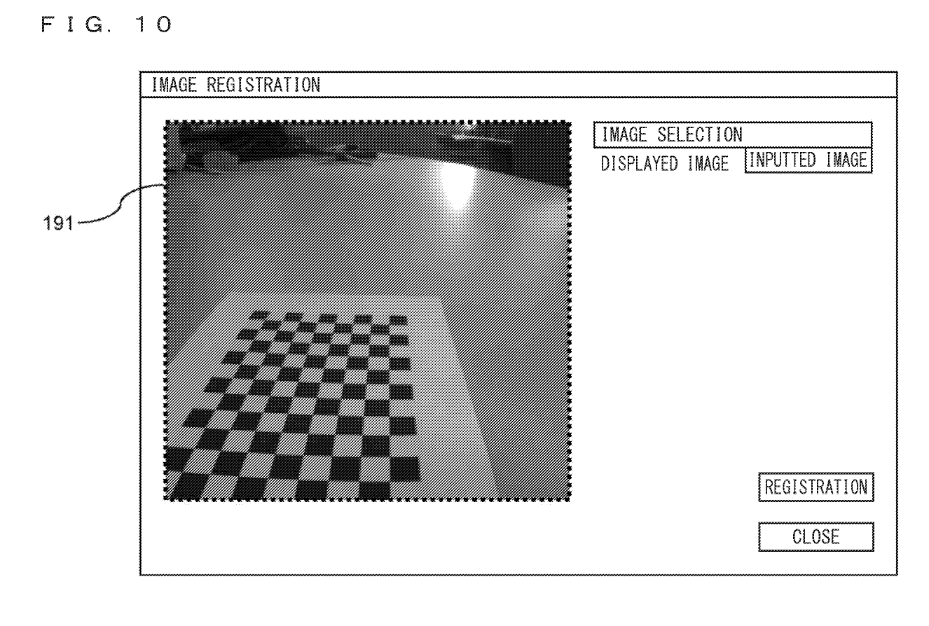

FIG. 10 is an illustrative view showing the image registration screen for acquiring the calibration pattern image of the image processing apparatus 2 according to the embodiment of the present invention. In the example shown in FIG. 10, the image last acquired by the camera 1 is displayed in the calibration pattern image display area 191. By selecting the “registration” button, the currently displayed image is stored in the calibration pattern image data storage unit 231 as the image data used for the calibration.

It should be noted that when specification of changing the number of calibration pattern images used for executing the calibration is accepted in the teaching image number setting area 193 described above, for example, when specification for changing the number from one to three is accepted, it is possible to acquire a new calibration pattern image by activating the image registration screen shown in FIG. 10 by accepting the specification of an unacquired registration number as an input of the registration number in the calibration pattern image setting area 195 and selecting the “image registration” button.

Referring back to FIG. 9, the calibration is executed by selecting a calibration execution instructing button 196. In a calibration result display area 197, the number of the feature points that have been used (the number of effective points), an average error, a maximum error, and a status are displayed as the result of the execution of the calibration.

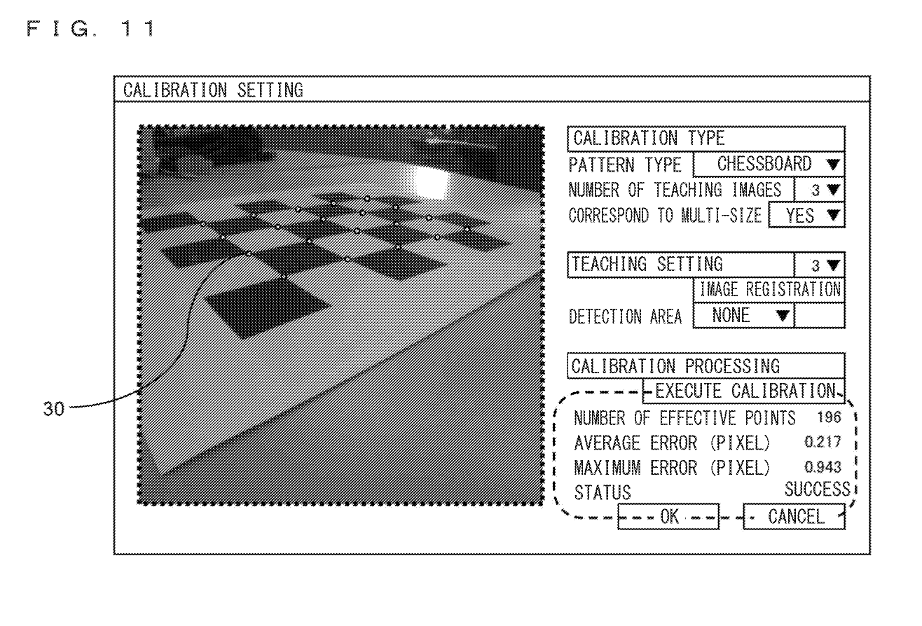

FIG. 11 is an illustrative view showing the calibration setting screen for presenting the result of the execution of the calibration of the image processing apparatus 2 according to the embodiment of the present invention. In the example shown in FIG. 11, the status is “success”, which indicates that the calibration has been completed normally.

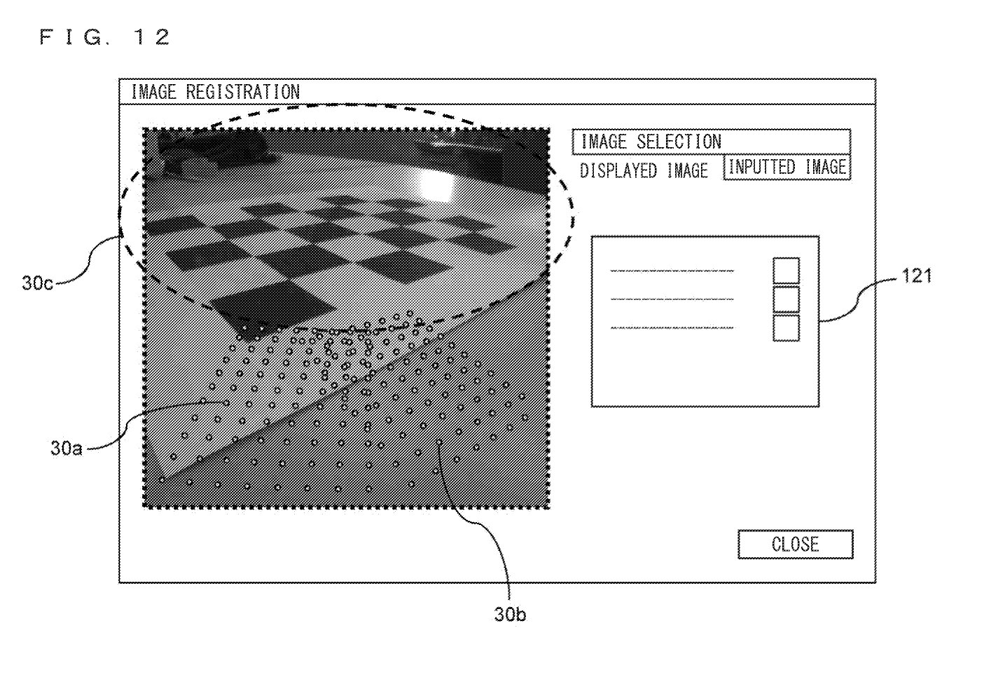

It is preferable that the positions of the feature points used to execute the calibration in the calibration pattern image can be confirmed in the display screen. Further, as the feature point display device 88 shown in FIG. 2, when a new image is to be registered in the image registration screen, it is preferable to display the new image overlapping with the extracted feature point group in the calibration pattern image that has been already registered. FIG. 12 is an illustrative view showing the image registration screen for registering the calibration pattern image data of the image processing apparatus 2 according to the embodiment of the present invention.

As shown in FIG. 12, the feature point groups 30a and 30b extracted from the calibration pattern images that have been already stored are displayed in a different manner, for example, in a different color. In the example shown in FIG. 12, it is determined that an upper half is not sufficiently covered while a lower half of the display screen is covered, and it is possible to execute the calibration for an entire display screen, for example, by making the arrangement of the calibration pattern image to be acquired next to overlap with an unextracted area 30c in the feature point group.

Further, it is possible to display which calibration pattern image corresponds in a feature point correspondence display area 121 according to the display manner. In this manner, it is possible to set an arrangement of the next calibration pattern image while visually confirming which feature point group corresponds to which calibration pattern image, which is effective.

Moreover, it is possible to display an extraction area which is an area from which the feature point group can be extracted. A coordinate position of a boundary of an area from which the feature point group can be extracted is stored in association with the image data for each calibration pattern image as an extraction area display device. Accordingly, by changing the arrangement of the calibration pattern image, it is possible to visually confirm whether or not the areas from which the feature point group can be extracted are overlapping, and to execute the calibration with higher accuracy by arranging so as to cover the entire display screen as much as possible without making the extraction areas to be overlapped.

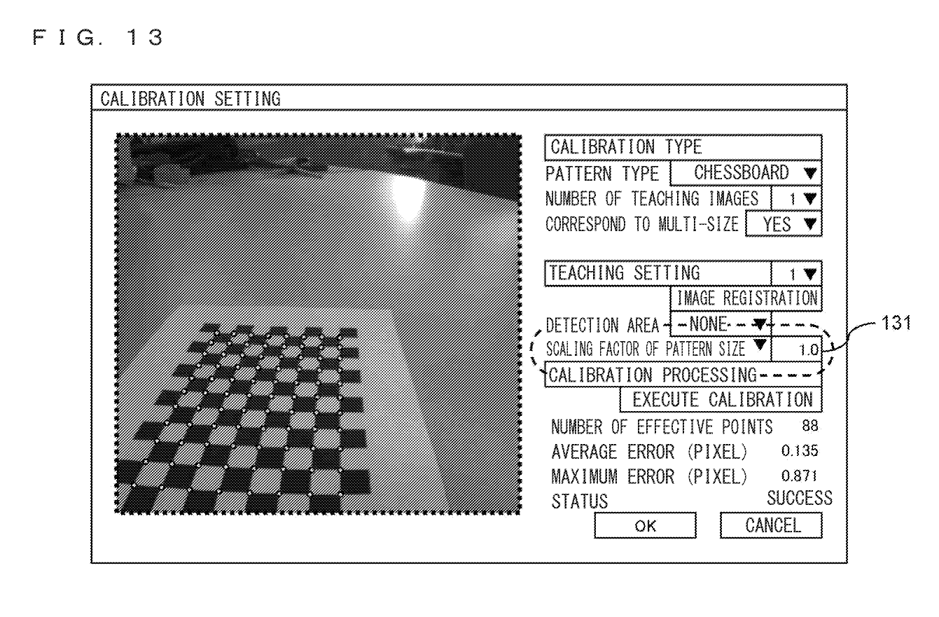

Furthermore, when the size of the scaling factor α out of the affine transformation parameters can be specified in advance, it is preferable that it is possible to easily set in the display screen. FIG. 13 is an illustrative view showing the calibration setting screen with which the scaling factor α can be set in the image processing apparatus 2 according to the embodiment of the present invention.

As shown in FIG. 13, a pattern size scaling factor input area 131 is provided, and it is possible to set the calibration pattern image of any magnification ratio by inputting the value of the scaling factor α with respect to the reference image. Note that the present invention is not particularly limited to inputting of the value of the scaling factor α, and, for example, it is possible to internally calculate and use the scaling factor α by inputting an actual value of the pattern size.

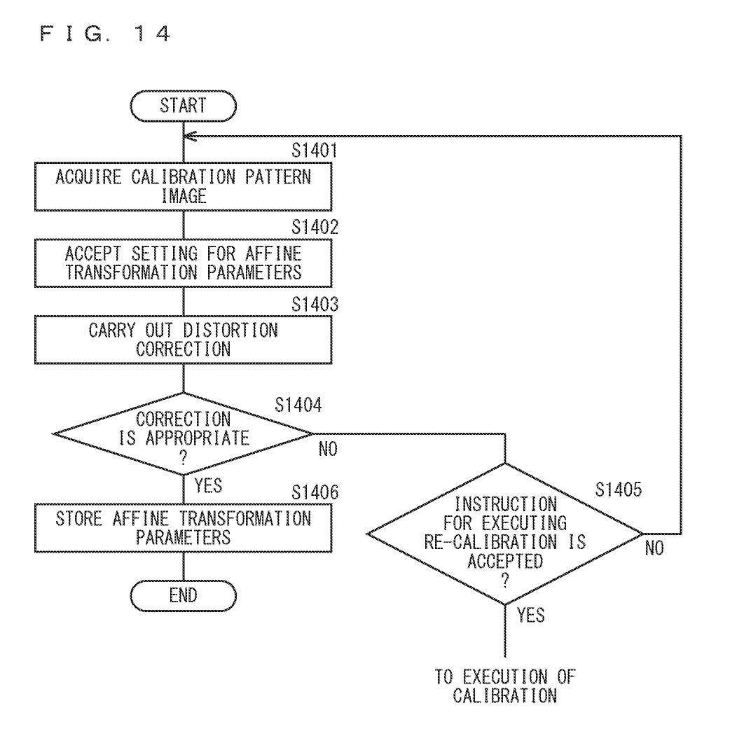

FIG. 14 is a flowchart showing processing steps of image processing after the execution of the calibration by the main control section 21 of the image processing section 7 in the image processing apparatus 2 according to the embodiment of the present invention. Each of the processing steps in the image processing method according to the embodiment of the present invention is executed according to the computer program 5 of the present invention that is internally stored in the image processing section 7.

In FIG. 14, the main control section 21 of the image processing section 7 acquires the calibration pattern image (step S1401), and accepts the setting of the affine transformation parameter (step S1402). The calibration pattern image to be acquired can be the same as or different from that in the execution of the calibration.

The main control section 21 executes the distortion correction based on the affine transformation parameters whose setting has been accepted, and the projective transformation parameters and the lens distortion parameters that have been optimized and stored by the execution of the calibration described above (step S1403), and determines whether or not the distortion correction is appropriate (step S1404). If the main control section 21 determines that the distortion correction is not appropriate (step S1404: NO), the main control section 21 again determines whether or not the instruction for executing the calibration has been accepted (step S1405).

If the main control section 21 determines that the instruction for executing the calibration has not been accepted (step S1405: NO), the process returns to step S1401 and the main control section 21 repeats the steps described above. If the main control section 21 determines that the instruction for executing the calibration has been accepted (step S1405: YES), the main control section 21 executes the calibration shown in FIG. 8 after adjusting the setting shown in FIG. 9.

If the main control section 21 determines that the distortion correction is appropriate (step S1404: YES), the main control section 21 stores the affine transformation parameters whose setting has been accepted by associating with the projective transformation parameters and the lens distortion parameters that have been optimized and stored by the execution of the calibration in the storage device 23 (step S1406).

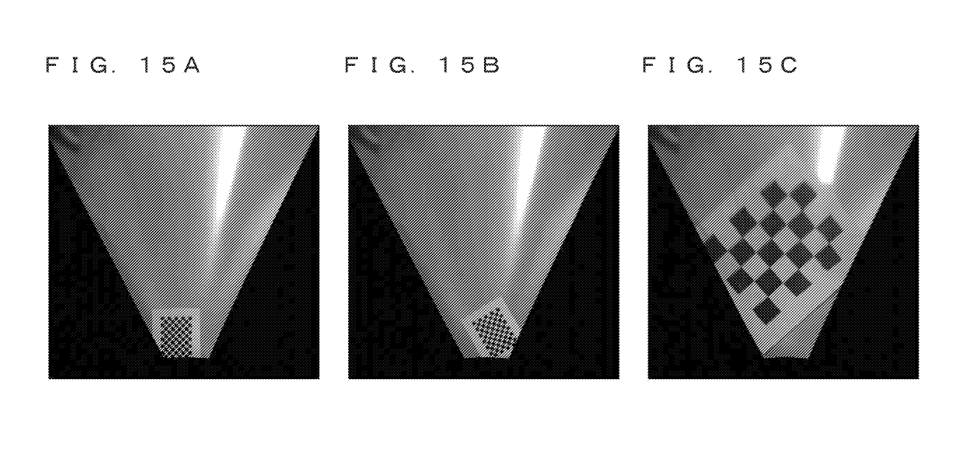

FIGS. 15A to 15C are illustrative views each showing an image after the distortion correction. FIGS. 15A to 15C respectively show post-correction images corresponding to FIGS. 4A to 4C.

In the example shown in FIG. 15A, as FIG. 4A is used as the reference image and the affine transformation parameters are set such that the reference image is upright, the reference image is arranged along the X axis and the Y axis. As the affine transformation parameters are set such that the reference image is upright, it can be seen from FIG. 15B and FIG. 15C that the other calibration pattern images are shown in a manner that the arrangement of the pattern is displaced as the arrangement is changed from the reference image.

Although an image in which the calibration pattern image is corrected is shown as an example in FIGS. 15A to 15C, the correction is repeated to a last inputted image instead of the calibration pattern image in an actual use, and the post-correction image is displayed in real time. Accordingly, even when the image of the test object is picked up in an oblique manner, for example, the image is constantly corrected and displayed as an image picked up from immediately above, and therefore it is possible to increase the reliability of the inspection and the like in the post-processing.

Further, according to the present embodiment, a method of directly correcting an image itself is described as a method of carrying out the distortion correction. However, it is possible to correct a result of measurement (such as the coordinate data) after carrying out desired processing to an uncorrected image without correcting the image itself. When employing the method of numerically correcting only the result of measurement without correcting the image itself, it is possible to save time required for correcting the image and to carry out the distortion correction at a high speed. However, as it is necessary to directly perform the measurement processing to a distorted image, this method is effective in the case in which a magnitude of the distortion is relatively small or the measurement processing is insusceptible to the distortion.

As described above, according to the present embodiment, the feature point groups are extracted from different areas based on the calibration pattern images in which the intervals between the feature points are different. Therefore, it is possible to reduce an area in which the feature points is difficult to be extracted, and it is possible to execute the calibration in a wider area. For example, the calibration pattern image in which the intervals between the feature points are narrow is used in the area in which the feature points can be sparsely shown, and the calibration pattern image in which the intervals between the feature points are wide is used in the area in which the feature points can be densely shown, and whereby it is possible to execute the calibration in a wider area with high accuracy.

It should be appreciated that the present invention is not limited to the above-described embodiment and can be modified and improved in various ways within the spirit and the scope of the present invention.

What is claimed is:

1. An image processing apparatus that performs distortion correction by acquiring a calibration pattern image using an imaging device and by executing calibration based on the acquired calibration pattern image, the image processing apparatus comprising:
a first extraction device that acquires a calibration pattern image in which first feature points arranged in an imaging range pickable by the imaging device are provided at a first interval and that extracts a first feature point group; and
a second extraction device that acquires a calibration pattern image in which second feature points arranged in an imaging range pickable by the imaging device are provided at a second interval and that extracts a second feature point group, wherein
the calibration is executed based on the first feature point group and the second feature point group respectively extracted from areas with different imaging ranges.

2. The image processing apparatus according to claim 1, wherein
the second interval is set so as to be wider than the first interval, and
the first extraction device extracts the first feature point group in an area in which the feature points are sparsely shown, and the second extraction device extracts the second feature point group in an area in which the feature points are densely shown.

3. The image processing apparatus according to claim 2, further comprising:
a setting device that sets one of a plurality of calibration pattern images as a reference image;
a projective transformation parameter setting device that sets projective transformation parameters indicating a relation between a first coordinate system and a second coordinate system, the first coordinate system representing the reference image shown in a planar view, the second coordinate system being for displaying the reference image;
an affine transformation parameter setting device that sets a relation between the reference image and the calibration pattern image other than the reference image by affine transformation parameters including a scaling factor in the first coordinate system based on the reference image;
a lens distortion parameter setting device that sets lens distortion parameters for correcting lens distortion and a relation between the lens distortion parameters by the imaging device; and
a parameter optimizing device that optimizes the projective transformation parameters, the affine transformation parameters, and the lens distortion parameters based on coordinate data based on the reference image in the first coordinate system and coordinate data of the feature points in a plurality of arrangements including the reference image displayed in the second coordinate system.

4. The image processing apparatus according to claim 3, further comprising:
a projective transformation parameter calculating device that calculates estimated values of the projective transformation parameters on an assumption that the lens distortion is not present; and
an affine transformation parameter calculating device that calculates estimated values of the affine transformation parameters on the assumption that the lens distortion is not present, wherein
the parameter optimizing device optimizes the projective transformation parameters, the affine transformation parameters, and the lens distortion parameters, taking the estimated values of the projective transformation parameters and the estimated values of the affine transformation parameters as initial values.

5. The image processing apparatus according to claim 1, further comprising:
a selection accepting device that accepts a selection between whether or not more than one calibration pattern images are used.

6. The image processing apparatus according to claim 5, further comprising:
a feature point display device that displays at least one of the first feature point group and the second feature point group used for executing the calibration.

7. The image processing apparatus according to claim 5, further comprising:
an acquisition instruction accepting device that accepts an input of an instruction of re-acquisition to the imaging device for each calibration pattern image that are accepted to be selected by the selection setting accepting device.

8. The image processing apparatus according to claim 1, further comprising:
an extraction area display device that displays an area from which at least one of the first feature point group and the second feature point group is extracted.

9. An image processing method capable of being carried out by an image processing apparatus that performs distortion correction by acquiring a calibration pattern image using an imaging device and by executing calibration based on the acquired calibration pattern image, the method comprising the steps of
acquiring a calibration pattern image in which first feature points arranged in an imaging range pickable by the imaging device are provided at a first interval and to extract a first feature point group;
acquiring a calibration pattern image in which second feature points arranged in an imaging range pickable by the imaging device are provided at a second interval and to extract a second feature point group; and
executing the calibration based on the first feature point group and the second feature point group respectively extracted from areas with different imaging ranges.

10. A computer program capable of being executed on an image processing apparatus that performs distortion correction by acquiring a calibration pattern image using an imaging device and by executing calibration based on the acquired calibration pattern image, the computer program causing the image processing apparatus to function as:
a first extraction device that acquires a calibration pattern image in which first feature points arranged in an imaging range pickable by the imaging device are provided at a first interval and that extracts a first feature point group;
a second extraction device that acquires a calibration pattern image in which second feature points arranged in an imaging range pickable by the imaging device are provided at a second interval and that extracts a second feature point group; and
a device that executes the calibration based on the first feature point group and the second feature point group respectively extracted from areas with different imaging ranges.
